(19) United States
(12) Patent Application Publication
(10) Pub. No.: US 2003/0055671 A1
(43) Pub. Date: Mar. 20, 2003

(54) Armored data services

(76) Inventor: Ramzi Nassar, Longwood, FL (US)

Correspondence Address: LAW OFFICES OF BRIAN S STEINBERGER, 101 BREVARD AVENUE, COCOA, FL, 32922, US

(21) Appl. No.: 10/230,233

(22) Filed: Aug. 28, 2002

Related U.S. Application Data
(60) Provisional application No. 60/315,679, filed on Aug. 29, 2001.

(51) Int. Cl. G06F 17/30; G06F 17/60

(52) U.S. Cl. 705/1; 707/204; 711/162

(57) ABSTRACT

Methods and systems for using mobilie vehicles such as not limited to armored trucks, vans, automobiles, and customized vehicles, for traveling to sites where computer information is created and/or used and/or disseminated for securing the computer information. Computer information data can be downloaded to the mobile vehicles by direct hardwire and/or wireless communications through cables, fiber optic cables, and conductors. The invention allows companies to back up and retrieve their data in a very safe and secure manner and have it transported to an off-site safe haven. Information such as 1 Giga Byte (GB) of information can be backed up in less than approximately 10 minutes with the novel invention.

This invention relates to securing computer information, and in particular to methods and systems for providing backup, storage and recovery of data such as computer data, proprietary data, analog data, digital data, and magnetic storage medium data, by utilizing mobile vehicles which physically travel to onsite locations where data is located, created, used, stored and disseminated, so that the computer data can be downloaded directly to the vehicles for storage, backup and future recovery, as well as for transporting the vehicle stored data to remote locations for additional storage, backup and/or future recovery, and this invention claims the benefit of priority to U.S. Provisional Application Serial No. 60/315,579 filed Aug. 29, 2001.

### BACKGROUND OF THE INVENTION

The creation of computer data, the storage of the data, the security of the data, and the possibility for its efficient recovery, are all critical components for the success of big and small companies and organizations. Companies and organizations today face the challenge of managing and storing massive amounts of mission-critical data, with market conditions making the proper management of that data a fiscal concern. Central to this challenge is that data can never be properly replaced; it can only be protected against loss. Risks to data include hardware failure, software failure, file system corruption, accidental deletion, virus infection, theft, disgruntled employee sabotage and natural disaster.

Industry trend and business demands currently include a Paradigm Shift from cash to data. In order to compete businesses are migrating to information-based technologies. Corporations are experiencing an exponential growth, an increased valuation, and a significant dependency upon their data. Corporations are building business models based upon shared data, and privacy and security which together are becoming a critical success

For business demands, data is becoming more valuable than cash. Gaps currently exist between the data growth and ability to protect and secure the data. Additionally, significant financial risks as well as criminal consequences are associated with loss of data. Also, increases in corporate strategic alliances are creating an interdependency of shared data resources. For most businesses, a loss of a partner's data could cause a potentially disastrous disruption to all the other partner's businesses.

Current backup processes of computer data generally fall into two categories: onsite backup to a storage medium, and online backup to a remote site. Both methods experience major drawbacks such as high price, lack of security and lengthy data recovery time frames that can affect a company's bottom line to the extent of financial viability

The physical storage medium includes magnetic and/or optical Based Backup such as tape, Cdrom (compact disc), and the like. The physical storage mediums have many problems. For example, the physical mediums can become lost, stolen, sabotaged and easily damaged.

The online backup requires connections by fiber, telephone, wire, cellular, distant connections that also have many problems. Cyber hackers and others can potentially tap into those connections and steal and even potentially destroy the data being backed up. While scrambling of data and encryption coding is available, the data being backed up still must pass through unprotected connections and airspace and is also susceptible to external and new viruses undetectable by typical virus protection systems.

All basic types of data backup are also prone to loss and damage from acts of nature such as storms, lightening, water damage, and the like, as well as purposeful acts such as theft and destruction.

Recent studies in 2002 have shown that approximately 93 percent of companies that lose their data with no data recovery plan in place will go out of business. Another recent study has held that managed storage market is expected to grow from approximately $2 billion in year 2000 to over $ 10 billion in 2004, and it has determined that by year 2006, it is predicted that more than 50 percent of companies will have one data center and will use a third party for disaster protection.

In addition to general market conditions, two driving forces support the demand for enhanced data backup and storage; increased awareness regarding disaster recovery after Sep. 11, 2001 disaster, and the HIPAA act, the Health Insurance Portability and Accountability Act, which requires compliance with the new regulations by April 2003.

The September 11 disaster resulted in the obliteration of incredible amounts of computer data records that were stored onsite adjacent to the World Trade Center. For example, many brokerage houses lost complete data record files on many of the individual clients since the data records were not physically located at different locations. It has been estimated that approximately 150 of the approximately 350 businesses affected by the bombing of the World Trade Center in 1993 never reopened. If data were recoverable, many of these businesses would have survived.

The newly enacted HIPAA act imposes stringent privacy and security requirements on health plans, health care providers, and health care clearinghouses that maintain and/or transmit individual health information in electronic form. The new Privacy and Security Standard will provide a standard level of protection in an environment where health information pertaining to an individual is housed electronically and/or is transmitted over telecommunications systems/networks.

Additionally, federal government regulations, Gramm Leach and Bliley Act, mandate that financial and banking transactions and records be backed up off-site in a secure and confidential manner, thus making remote data storage and recovery a necessity.

Thus, there exists the need for solutions to the above problems.

### SUMMARY OF THE INVENTION

The primary objective of the invention is to provide methods and systems for corporations, businesses and individuals' capability to backup and retrieve their data that is substantially more safe and secure than existing onsite storage mediums or remote off-site storage locales that receive data by wire or wireless transmissions.

The secondary objective of the invention is to provide methods and systems for the backup, storage and recovery of data namely computer data, proprietary data, analog data, digital data, and magnetic storage medium data, utilizing physically adjacent storage vehicles namely trucks, armored trucks, vans, automobiles, and customized vehicles to travel onsite to locations where data is located, created, stored, disseminated, and used.

The third objective of the invention is to provide methods and systems for direct hardwire and/or wireless communications through cables, fiber optic cables, and conductors, to download data namely computer data, proprietary data, analog data, digital data, and magnetic storage medium data directly to the storage mediums onto physically adjacent vehicles for storage, backup and future recovery.

The fourth objective of the invention is to provide methods and systems having the capability of transporting and driving vehicle stored data namely computer data, proprietary data, analog data, digital data, and magnetic storage medium data, to remote locations for storage, backup and future recovery.

The fifth objective of the invention is to provide methods and systems for the storage, backup and future recovery of computer data that would eliminate the catastrophic loss of data that can occur as a result of manmade and natural disasters.

The sixth objective of the invention is to provide methods and systems for the storage, backup and future recovery of computer data that meets the governments laws and rules for data storage, backup and future recovery.

The seventh objective of the invention is to provide methods and systems for the storage, backup and future recovery of computer data that is substantially more economical and cheaper than existing onsite storage mediums and remote sites that are accessed by hardwire and wireless systems.

The subject invention systems and methods would have prevented the massive amount of data lost as a result of the Sep. 11, 2001 disaster. The novel methods and systems address the HIPAA requirements and the other federal government regulations referred to in the background section of this invention by offering methods and systems that would be fully compliant and secure for transporting electronic medical records and data.

A preferred embodiment of this invention relies on using armored trucks and current off the shelf computer systems and technology combined in a unique manner for achieving the objectives described above.

The invention provides small, medium and large-sized companies with enterprise-wide mobile data backup, and disaster recovery services in addition to very secure fiber optic facilities. The invention also provides a variety of data backup services, including downloading, pick-up and delivery of customer backup information using secure vehicles such as armored trucks. The secure vehicles can be used on variable schedules, day or night, with a frequency of daily, weekly, and monthly.

The secure vehicles can be used to travel onsite to various locations such as but not limited to companies with medium to large-scale, off-site data storage and backup requirements. Furthermore, these locations can include but not be limited to large clinics, hospitals, colleges and universities, government agencies, and the like. The invention can be integrated as a service for businesses and entities and be priced at monthly costs that can be at least approximately 20 to approximately 30 percent less than any other medium of backup/recovery delivery. It is considered by a number of network security experts as one of the safest data backup methods that exist in the marketplace.

Further objects and advantages of this invention will be apparent from the following detailed description of a presently preferred embodiment which is illustrated schematically in the accompanying drawings.

### BRIEF DESCRIPTION OF THE INVENTION

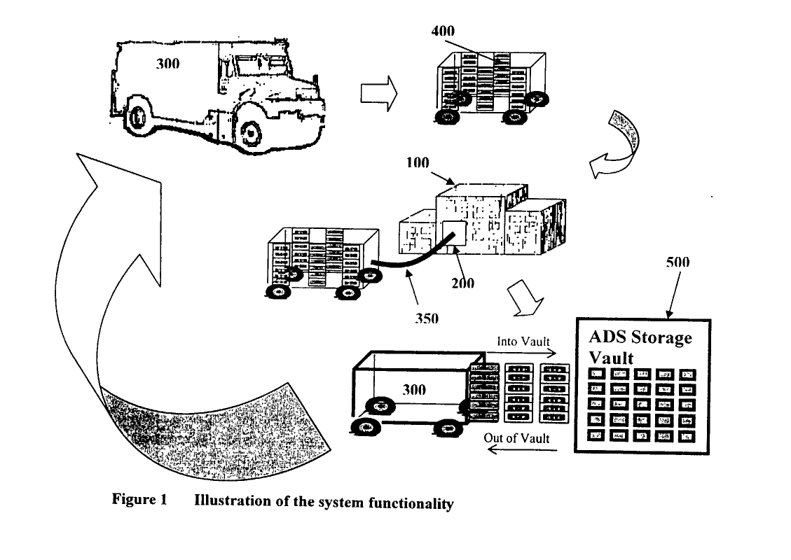

FIG. 1 illustrates a preferred layout of using the invention.

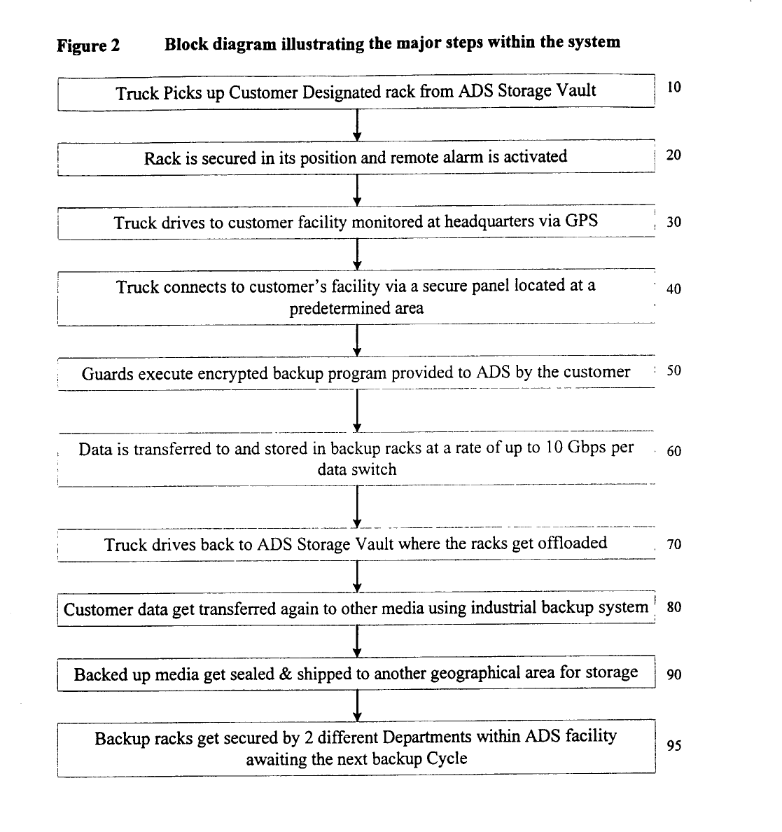

FIG. 2 is a flow chart of using the novel invention.

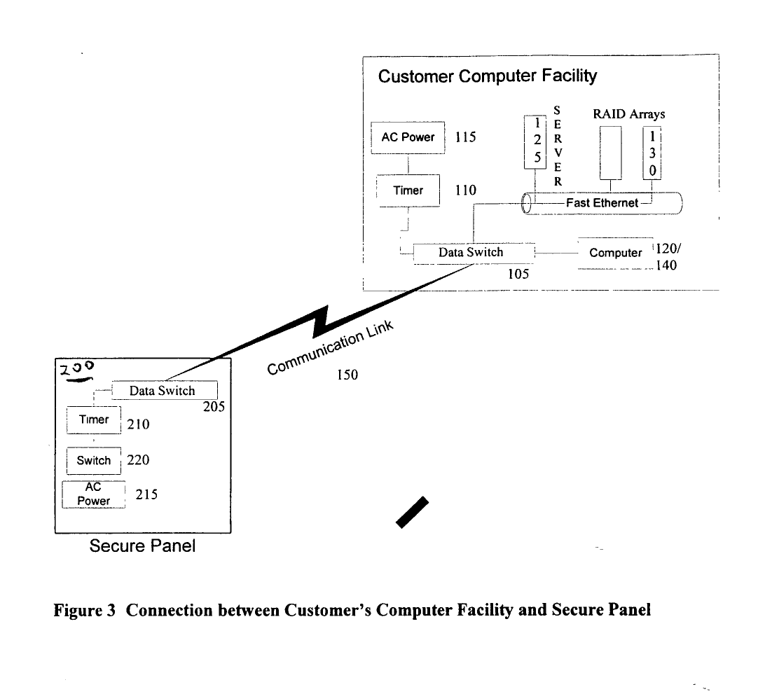

FIG. 3 shows the connection used between a customer's computer facility and the secure panel at the customer's facility.

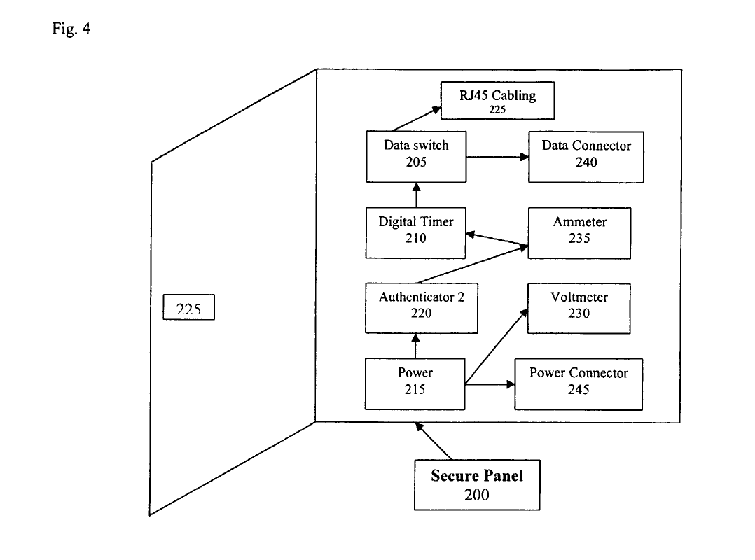

FIG. 4 shows a more detailed depiction of the controls on the secure panel.

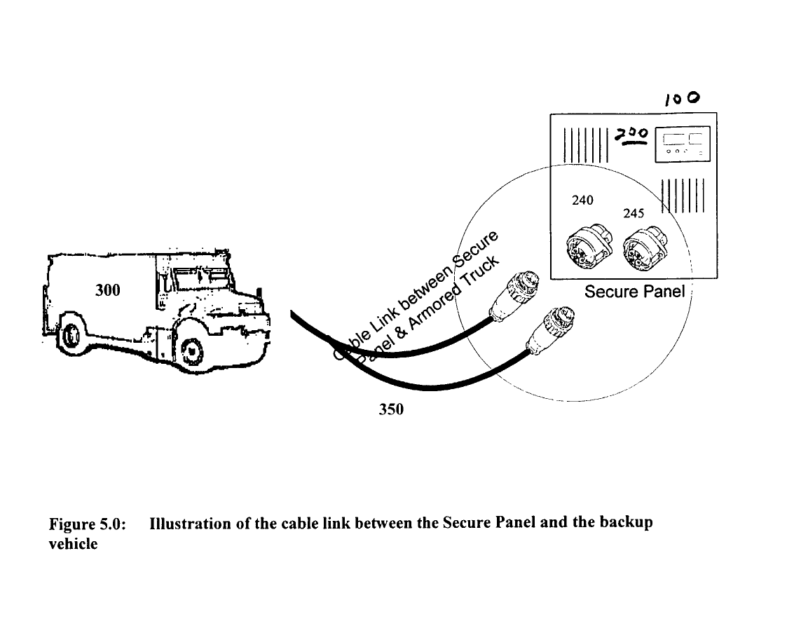

FIG. 5 shows a transmission medium connection between the secure panel and a storage vehicle.

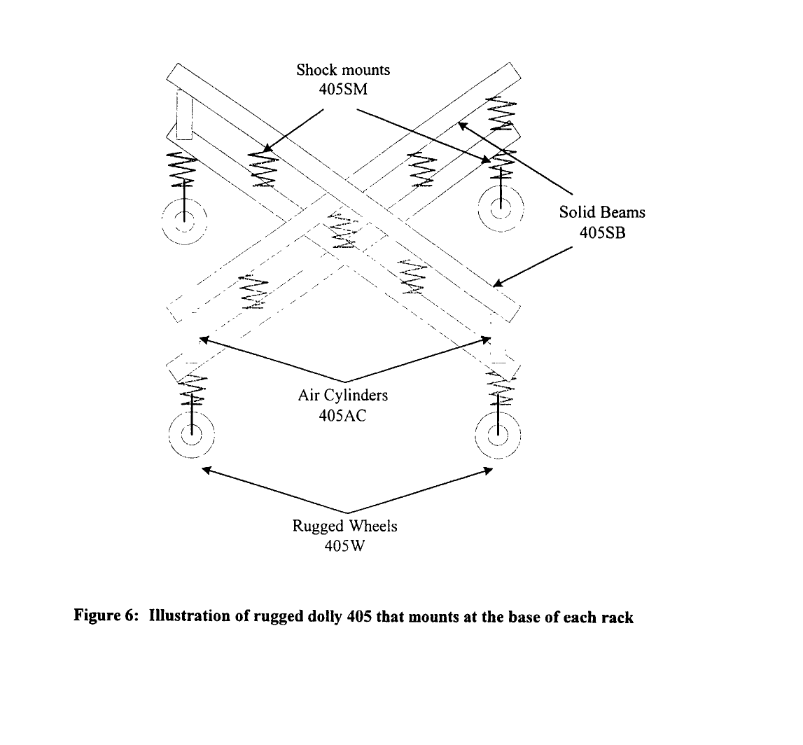

FIG. 6 is a perspective view of a novel mounting dolly that is used for each of the vehicle racks.

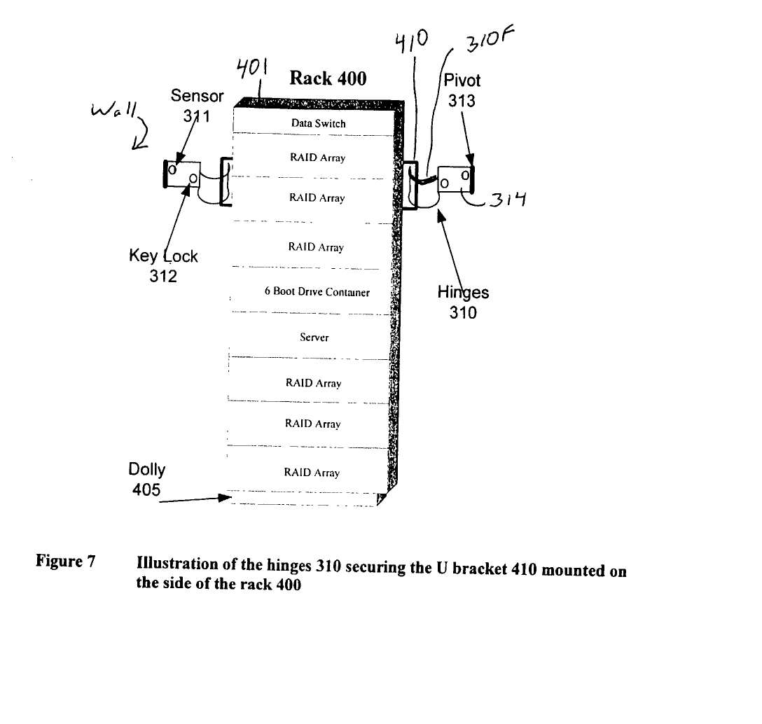

FIG. 7 is a front view of a storage rack on the dolly of FIG. 6 with wall attachment locks.

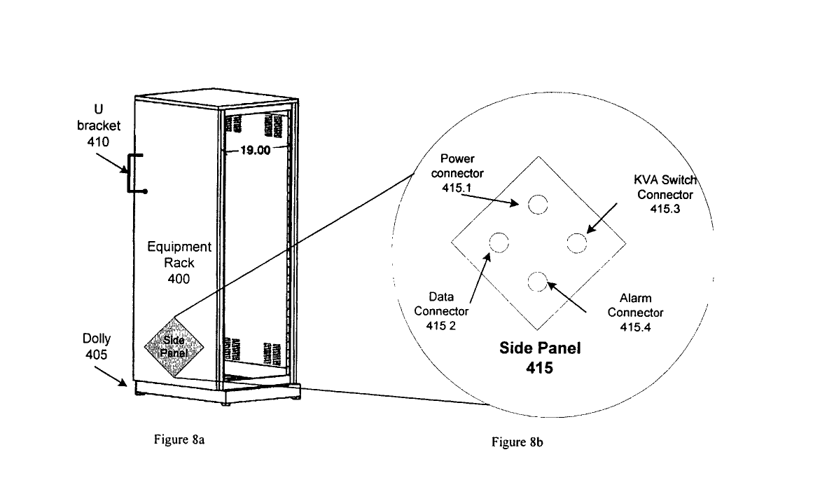

FIG. 8a is a perspective view of the storage rack of FIG. 7 with U-bracket detached from the wall.

FIG. 8b is an enlarged view of the side connector panel of FIG. 8a.

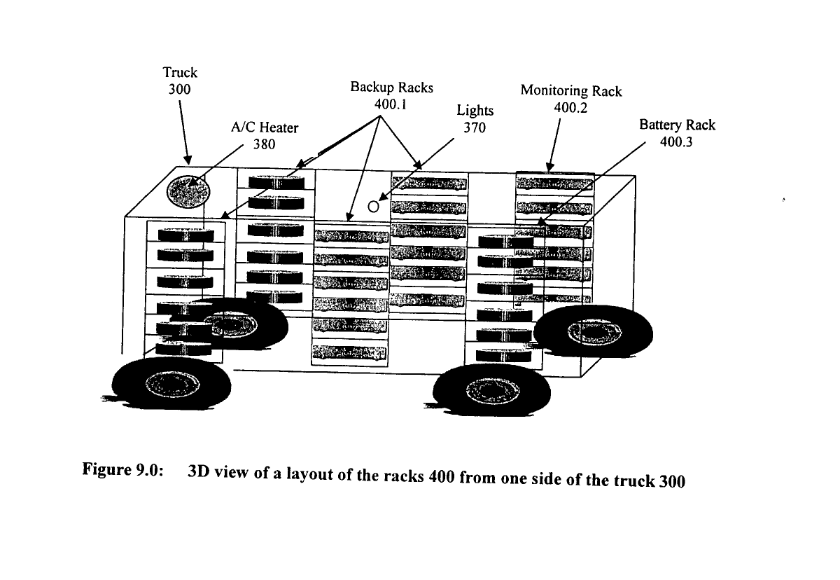

FIG. 9 is a breakaway view of the racks within a vehicle body.

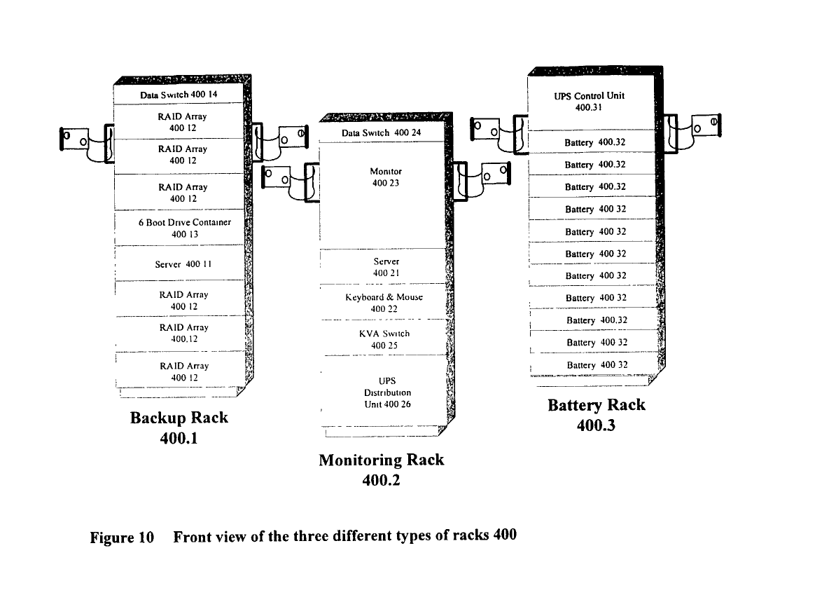

FIG. 10 is a front view of three racks that are stored within the vehicle body of FIG. 9.

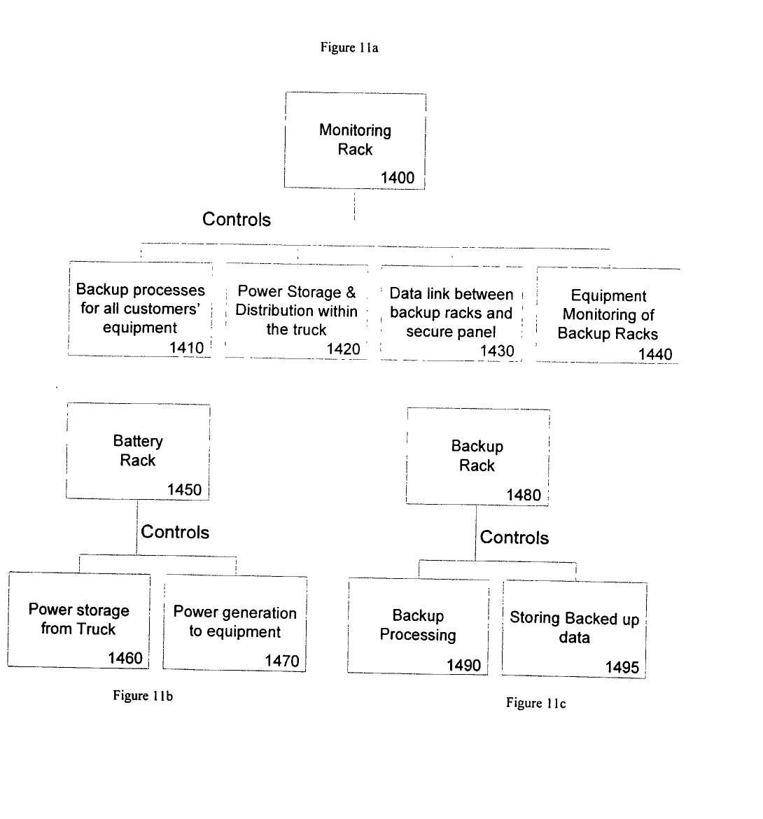

FIG. 11a is a control flow chart for the monitoring rack of the preceeding figures.

FIG. 11b is a control chart for the battery rack of the proceeding figures.

FIG. 11c is a control chart for the backup rack of the preceeding figures.

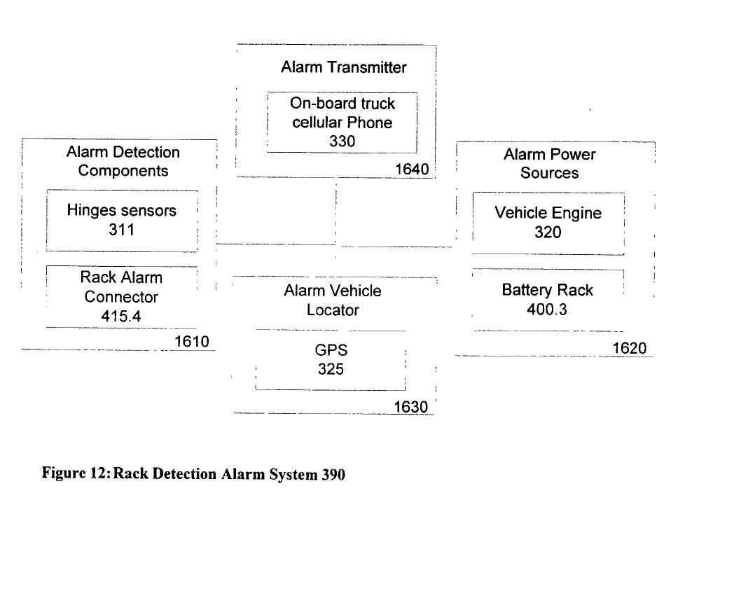

FIG. 12 is a flow chart for the rack detection alarm system for the invention.

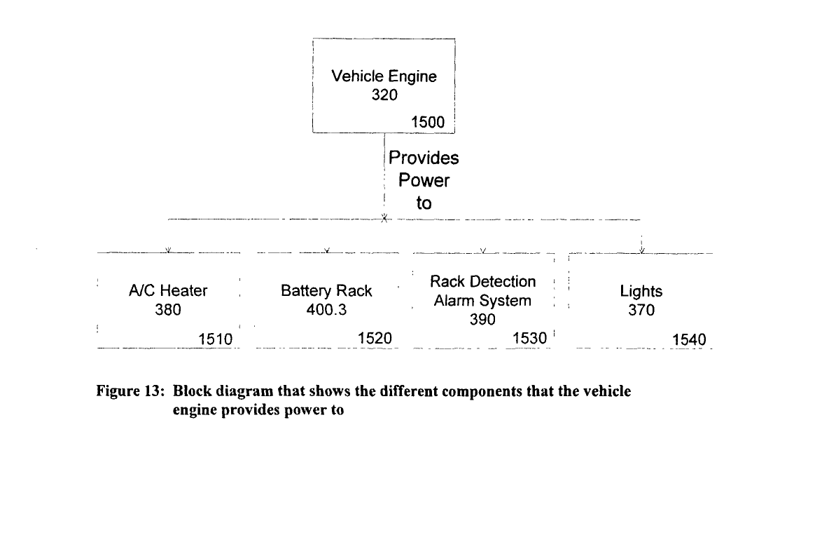

FIG. 13 is a flow chart block diagram for an application of the invention inside a vehicle.

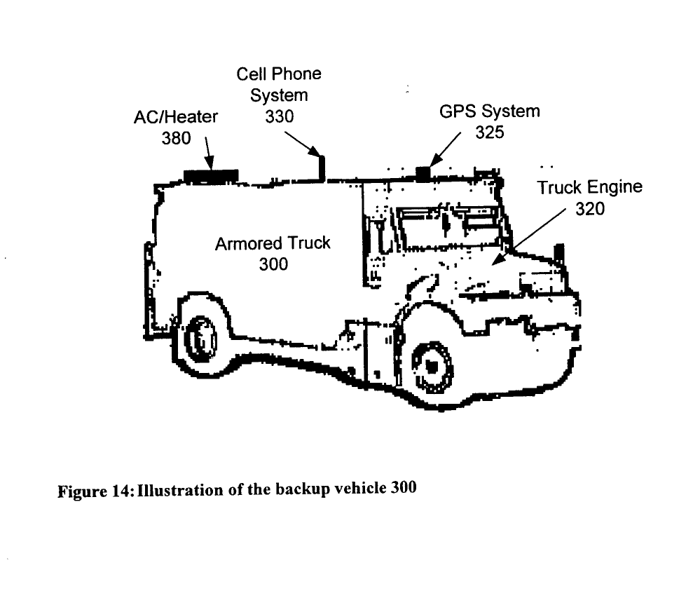

FIG. 14 is an illustration of the extra components for use with the backup vehicle.

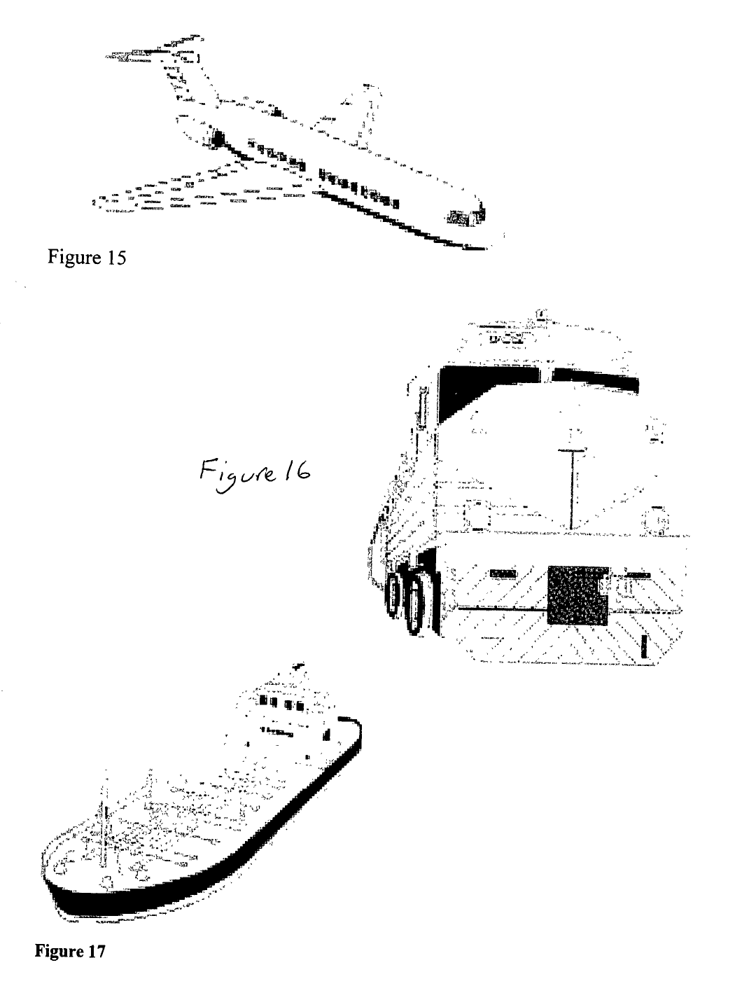

FIG. 15 shows a plane that can use the novel invention.

FIG. 16 shows a train that can use the novel invention.

FIG. 17 shows a watercraft boat that can use the novel invention.

### DETAILED DESCRIPTION OF THE PREFERRED EMBODIMENTS

Before explaining the disclosed embodiment of the present invention in detail it is to be understood that the invention is not limited in its application to the details of the particular arrangement shown since the invention is capable of other embodiments. Also, the terminology used herein is for the purpose of description and not of limitation.

The novel ADS backup system can be considered a third alternative method to be used in data backup and recovery beyond the well known uses of on-line and tape backup. The novel invention is more secure, faster, and more cost effective than the other backup methodologies. It can be operated at a rate of up to 10 gigabits per second per local area network.

The novel invention system includes strict and multi-layer security points. At no time, the data stored within it can be accessed without two independent authenticators which will be described later in greater detail. The circumvention of the security implemented within the system is close to impossible since the invention system requires:

(i) Physical presence at multiple locations simultaneously, including the presence of an intruder at the company's site, specifically within the computer facility

(ii) Proper and exact configuration of the equipment which is known only to few management employees within the customer's company

(iii) Exact timing to hack since the backup process is configured to operate within a specific time frame

(iv) Circumventing the silent alarm

The novel invention includes at least four main parts. (1) Secure Panel at the Clients Facility; (2) Connection between the Panel at the Clients Facility and the Backup Vehicle; (3) Internal and External Configuration of the Backup Vehicle; and (4) Securing Customer's Data at ADS's Facility.

FIG. 1 illustrates a preferred layout of the application of the novel invention. Referring to FIG. 1, an ADS (Armored Data Service) mobile vehicle 300, such as an armored bank truck, and the like, loaded with customers backup racks 400, can drive to a customer's site 100, hooks up a communication link 350 between the truck and a secure panel 200 (already mounted at a predetermined location at the customer site 100. The system 1 then uses a totally secure, risk-free standard methodology to backup customer's data without opening the truck. Once the customer's racks 400, located within ADS truck 300, are loaded with Customer Data, they are driven to ADS secure nearby facility 500, and off loaded to a secure vault area 500. The Customer backup data can now be stored in a totally safe and controlled environment physically offsite and remotely located from the customer's physical location.

FIG. 2 is a flow chart depicting the major 10 steps of a preferred application for using the novel invention. Referring to FIG. 2, step 10 truck pickup of designated rack 400 from storage vault 500, step 20 secure rack 400 on board 300, step 30, vehicle (truck) 300 drives to facility while being tracked by various technologies such as but not limited to Global Positioning System (GPS) 325, step 40, truck connects to facility via the control panel 200, step 50 guards execute encrypted backup program provided to service by customer, step 60 data is transferred to and stored in backup racks at rates of up to 10 Giga bits per second, step 70 truck drives back to storage vault, and can also be tracked via technology such as but not limited to GPS, step 80 customer data gets transferred again to other media using industrial backup system, step 90 backed up media can be sealed and shipped to another geographical area for storage, and step 95, backup racks get secured by two different departments within storage facility awaiting next backup cycle.

Secure Panel at the Clients Facility

FIG. 3 illustrates the secure connection between customer's computer facility 100 and the secure panel 200 physically mounted at the customer's facility ground floor such as but not limited to a loading dock. FIG. 3 consists of establishing a link between the customers' servers farm facility (Computer Facility) 100, and the Secure Panel 200. This link can be established using Fiber optic cabling, electrical cabling, wireless link and the like. For descriptive purpose, we will proceed with Category 5 RJ45 cabling 150. This cable 150, will link the data switch 105, (such as but not limited to a Gigabit Ethernet, Fast Ethernet, Ethernet, Wireless link, and the like) at the Computer Facility 100, and data switch 205, (such as but not limited to a Gigabit Ethernet, Fast Ethernet, Ethernet, Wireless link, and the like) installed within the Secure Panel 200. This connection can be controlled by commercially available off-the-shelf Simple Network Management Protocol (SNMP) software 140, of both data switches 105 & 205. This software can be installed on a secure off-line computer 120, and controlled by the customer's senior management personel. The purpose of using manageable data switches and the SNMP software is security, auditing capability, monitoring features, and accountability.

Referring to FIG. 3, a timer 110, such as but not limited to a digital timer can control the data switch power 115, at the customer facility 100, and another one located within the panel. These timers can be secured by a mechanical (key locks and/or combination locks), electrical keys (key pad controlled locks, and the like) and/or biometrics keys such as but not limited to finger print authenticators, eye retina scanners, facial image detectors, issued and monitored by the customer's senior management personnel. The purpose of using the timer is to limit the time window to access the data switches 105 and 205 at the secure panel 200 and the customer's facility 100 and that is for security reasons.

FIG. 4 shows a more detailed depiction of the controls on the secure panel 200 of FIGS. 1 and 3. The secure panel 200 can include but is not limited to an Electrical Panel. 205 refers to Data Switch, such as but not limited to a Gigabit Ethernet, Fast Ethernet, Ethernet, Wireless link, and the like. 210 refers to mechanical or digital Timer, such as but not limited to TR 104. 215 refers to AC Power, such as but not limited to 110 Volts. 220 refers to Authenticator 2, such as but not limited to a two positions key lock switch. 225, Authenticator 1, such as but not limited to an electronic switch such as a Keypad switch and/or a mechanical switch such as a key lock and/or combination lock. 230 refers to a digital panel voltmeter, such as but not limited to an LCD (Liquid Crystal Display ) panel display. 235 refers to a digital current meter, such as but not limited to an LCD panel display. 240 refers to a Data Connector, such as but not limited to an RJ45 connector, Fiber Optic connector and the like. 245 refers to a Power Connector, such as but not limited to an Amphenol power connector. 250 refers to data Cabling, such as but not limited to a Cat 5 RJ 45 shielded cable, Fiber Optic cable and the like.

The secure panel will be described in reference to FIG. 4. The secure panel 200, consists of multiple components which are described below. It is intended that at no time can the secure panel 200 be activated without at least two independent authenticators 220 & 225. These authenticators 220 & 225 can be mechanical (key locks and/or combination locks) and/or electrical locks (keypads with encryption codes), as well as biometrics such as but not limited to finger print authenticators. Since each mobile vehicle can be manned with two guards, each one of the guards can have an authentication means to activate the secure panel 200. For example, one Guard can control the access to the panel through the first authenticator 225 and the second Guard can control the activation of the power 215, to the data switch 205 within the panel 200 through the second authenticator 220.

Connection Between the Secure Panel and the Backup Vehicle

FIG. 5 shows a transmission medium connection between the secure panel 200 and a storage vehicle 300. While the data link segment is being described using fiber optic and/or electrical cabling, it is critical to emphasize that this link can be a wireless one as well. The cable connection 350 between the secure panel 200, and the backup vehicle 300 can be a customized cable carrying two components. For example, cable can include a power line and a shielded data line. This cable can be extended from the backup vehicle 300, and connected to the two connectors 240 and 245 (Data and Power Connections) located at the secure panel 200. Once these connections have been established, and the access codes have been authenticated 220, and assuming the timer 210 is set to the ON position (the time on both timers is set by the customer's senior management personnel) then the process of data backup can take place until all data has been transferred from the customer facility 100 to the backup vehicle 200. At this point, the guard(s) can power OFF the racks 400 within the vehicle 300, disconnect the extended cable 350, lock up the secure panel 200, and drive the vehicle 300 to the ADS (Armored Data Service) storage vault facility 500.

Internal and External Configuration of the Backup Vehicle

FIG. 6 is a perspective view of a novel mounting dolly 405 that is used for each of the vehicle racks 400 that will be described in reference to the later drawings. FIG. 7 is a front view of a storage rack 400 mounted on the dolly 405 of FIG. 6 with wall attachment locks. FIG. 8a is a perspective view of the storage rack 400 of FIG. 7 with U-bracket 410 detached from the wall. FIG. 8b is an enlarged view of the side connector panel 415 of FIG. 8a. FIG. 9 is a breakaway view of the racks 400, the AC/Heater 380, and the lights 370 within a vehicle body 300. FIG. 10 is a front view of three different racks 400.1, 400.2 and 400.3 that are stored within the vehicle body of FIG. 9.

Referring to FIGS. 6-10, the backup vehicle 300 can be a reinforced truck, such as but not limited to an armored bank type truck, and the like. However the invention can apply to any type of secure mobile transport vehicle that can be used for the purpose of backing up and recovering computer type data. The vehicle such as an armored bank type truck 300 can be modified internally to accommodate approximately six five-feet-high racks 400 (rack height could vary). Five of these racks 400 can then roll in and out of the truck/vehicle 300 on a scheduled basis such as but not limited to a daily basis or depending on the frequency of the scheduled backup. The sixth rack 400.3 will be installed permanently in the back of the truck 300.

FIG. 9 shows a breakaway view of a layout of the racks 400 inside the truck 300. Each one of the racks 400 can be mounted on a rugged dolly 405 (described in reference to FIG. 6) and be secured to the base of the rack 400, and supported with air suspensions and shock mounts. This configuration can allow each rack to withstand the sudden and constant impacts that can result from poor road conditions. FIG. 6 shows a detailed view of the dolly 405 that will be tightened to the base of the rack 400 while FIG. 8 shows a side view of the rack 400 mounted on the rugged dolly 405.

Referring to FIG. 6, the dolly 405 can include rugged wheels 405W, such as approximately 3 to approximately 5 inch diameter rubber edged wheels, casters, and the like, that are connected by shock mounts 405SM, such as springs, air cylinders, fluid shocks, and the like, to the under surface of a double crossed beams 405SB such as but not limited to aluminum metal and the like. Additional shock absorber members 405AC such as but not limited to air cylinders, springs, fluid shocks and the like, separate each pair of crossed beams from one another, so that the rack 400 can be springably suspended above ground level.

Referring to FIG. 7, in addition to the dolly 405, each rack 400 can be equipped with two solid U brackets 410 that allow it to be secured by the hinges mounted to the side of the truck. The C-shaped hinges 310 can be flexible enough around the U bracket 410 of the rack to allow it to move freely within range and provide enough room for the air suspension of the dolly 405 to function properly. Furthermore, each of the C-shaped hinges 310 can contain a sensor 310.1 such as but not limited to a photoelectric sensor, and the like, that can be used to detect the unauthorized opening of the hinges. Each C-shaped hinge 405 will also contains a lock such as but not limited to a mechanical key lock 310.2, and the lock, which can be locked when the racks 400 are loaded into the truck at ADS facility 500 and the key is kept at ADS facility 500 for security reasons.

Again, FIG. 7 illustrates the practical use of the hinges 310 and how they secure the rack 400 while mounted in the truck 300 and FIG. 8a shows a side view of how the U bracket is mounted on the side of the rack. Referring to FIG. 7, side brackets 410 can be pre-attached to outer side walls of the rack box 400. Mounted to an interior wall of the vehicle 300 by a pivoting hinge 313 can be locking plate 314, that can be connected to the wall by a lock 312 such as but not limited to a conventional key lock, and the like. A C-shaped hook members 310 can be attached to the moveable plate 314 so that it hooks about the U-brackets 410 on the rack 400. On the inner curved surface of the C-shaped hook members 310 can be compressible and/or elastic material 310F such as foam, rubber, combinations thereof and the like. The combination of the elastic material 310F on the sides of the rack 400 and the springably dolly 405 allows for movement of the rack 400 in both the vertical and horizontal directions which safely allows the rack 400 to move within the vehicle 300 as it rides over uneven terrain.

As previously noted FIG. 8a is a perspective view of the storage rack 400 of FIG. 7 with U-bracket 410 detached from the wall. FIG. 8b is an enlarged view of the side connector panel 415 of FIG. 8a. FIG. 9 is a breakaway view of the racks 400.1, 400.2, 400.3 within a vehicle body. FIG. 10 is a front view of three different rack types 400.1, 400.2, 400.3 that are stored within the vehicle body 300 of FIG. 9.

As previously mentioned, the truck/vehicle 300 can contain six racks 400 in total. Four of the racks 400 can be considered Backup racks 400.1, one will be considered Monitoring rack 400.2, and the sixth will be labeled Battery rack 400.3. FIG. 9.0 shows a breakaway view of the layout of the racks 400 from one side of the truck 300 and FIG. 10 shows a front view of the three different types of racks 400.1, 400.2, 400.3 which will be described below.

Backup Rack 400.1:

Referring to FIGS. 7, 9 and 10 each Backup Rack 400.1 can contains one server 400.11 such as but not limited to Pentium IV series with interchangeable boot drive slot, six Redundant Array of Independent Disks (RAID) arrays 400.12, corresponding to up to six customers (depending on storage size), a container 400.13 for exchangeable boot drives such as but not limited to Small Computer System Interface (SCSI) drives, and a data switch 400.14 such as but not limited to a Gigabit Ethernet, Fast Ethernet, Ethernet, Wireless link, and the like to connect the backup rack 400.1 to the monitoring rack 400.2 and to interconnect the RAID array drives 400.12 to the server 400.11 if necessary. Each of the boot drives 400.13 corresponds to each of the RAID array drives 400.12 installed within the same rack 400.

Referring to FIGS. 8a, 8b, 9 and 10, the power to all the equipment within each of the backup rack 400.1 can feed from the power connector 415.1 located within the side panel 415 of rack 400.1. The data switch 400.14 within the rack 400.1 can be connected to the data connector 415.2 located within the side panel 415. The monitor plug in the back of the server 400.11 can be connected to the KVA connector 415.3 located within the side panel 415, and the alarm connector 415.4 within the side panel 415 is connected to the internal wiring of the truck 300 for proper operation of the alarm.

FIG. 12 shows a block diagram that identifies the different components of the Rack Detection Alarm System (RDAS) 390. The purpose of RDAS is to notify ADS headquarters of any unscheduled movement of the racks from their latched positions. RDAS is activated and deactivated at the ADS facility 500 only. As illustrated in FIG. 12, block 1620 shows how RDAS 390 can have two redundant power sources, the vehicle engine 320 and the Battery Rack 400.3. Block 1610 shows the detection components of RDAS. When one of the hinges is opened or if the cable connected to the alarm connector 415.4 on the side panel 415 of each backup rack 400.1 get disconnected while the alarm is armed then RDAS triggers. Once it triggers, the cell phone system 330 onboard the truck 300, shown in block 1640, will dial ADS facility 500 and transmits the latest coordinates generated by the Ground Positioning System GPS) 325 shown in block 1630. At that point, ADS will be able to contact the proper authorities and provide them with the right coordinates of the truck.

FIG. 14 shows the truck/vehicle 300 with the AC/Heater 380, cell phone system 330, GPS system 325, truck engine 320.

The connection of each of the backup racks 400.1 to the monitoring rack 400.2 will be described later in detail.

Monitoring Rack 400.2:

Referring to FIGS. 8, 9 and 10, the Monitoring Rack 400.2 can be used to control and monitor the operation of the other racks within the truck 300, the Backup racks 400.1 and the Battery rack 400.3. The monitoring rack 400.2 can also be the interface that connects the backup racks 400.1 with the customer's facility 100 via the secure panel 200 and the connecting cable 350. The Monitoring Rack 400.2 can contain the following components:

a basic server 400.21 such as but not limited to Pentium IV series with interchangeable boot drive

a data switch 400.24 (Gigabit/Fast Ethernet/ Ethernet/ Wireless/ etc.) such as but not limited to fast Ethernet switch

a monitor screen 400.23, a keyboard and a mouse 400.22 where all three are connected to a KVA switch 400.25

Uninterrupted Power Supply distribution unit (UPS) 400.26 designated to power distribution to all the racks within the truck. The UPS distribution unit is fed its power from the battery rack. The UPS unit can provide enough power for two racks to operate for a period of three hours without any external power connected to it. However, as shown in FIG. 13 block 1520 the battery rack 400.3 gets powered by the truck engine block 320 (1500).

Referring to FIGS. 8, 9 and 10, the server 400.21 can be used as the common interface that allows the computer operator, in this case the guards, within the truck/vehicle 300 to execute the backup operation of each of the backup racks 400.1. The data switch 400.24 can be used to interconnect the racks 400.1 located within the truck 300 and to interface with the data switch 205 installed within the secure panel 200 at the customer's facility 100. Each data connector 415.2 on the side panel 415 of the backup rack 400.1 can be connected to the data switch 400.24 in the monitoring rack 400.2

Referring to FIG. 10, the monitor 400.23, the keyboard and mouse 400.22 can be connected to the master connectors of the KVA Switch located within the same rack 400.2. Using this KVA Switch, a system operator, in this case a guard, can alternate from one backup server 400.11 to another of the backup racks 400.1 with a push of a button. The internal cabling within the truck connect each KVA switch connector 415.3 located within the side panel 415 of each backup rack 400.1 to the slave connectors located on the back of the KVA switch 400.25.

Referring to FIG. 10, the Uninterrupted Power Supply (UPS) distribution unit 400.26, powered by the battery rack 400.3, is used as the main power distributor to all the equipment located within the truck 300. Each of the power connectors 415.1 located within the side panel 415 of the backup rack 400.1 will feed into this unit. In addition, all equipment, within the monitoring rack 400.2, get powered by this unit.

The block diagrams shown in FIGS. 11a, 11b and 11c summarize the functionality of each type of the six racks secured within the truck.

FIG. 11a is a control flow chart for the monitoring rack of the preceeding figures. Referring to FIG. 11a, a purpose of the monitoring rack 400.2 (block 1400) is to interface between the backup racks 400.3 and the customer's facility 100 via the secure panel 200 (block 1430), to distribute power and data among the racks 400 within the truck 300 (block 1420), to provide monitoring capability of backup racks 400.1 within the truck (block 1440), and to execute the backup process within the racks 400.1 (block 1410).

Referring to FIG. 11b, Battery rack 1450 gets power from the power generation 1470 (alternator to be described later) in the vehicle/truck, and provides power stored within its battery system 1460 to the monitoring rack which can redistribute power to other components in the racks.

Referring to FIG. 11c, Backup rack 1480 controls the backup processing 1490 which is downloading the data from the computer facility to the backup racks on the truck/vehicle, and also stores the backed up data 1495.

Battery Rack 400.3:

Referring to FIGS. 9, 10, 13 and 14, the battery rack 400.3 can be mounted permanently within the truck. The battery system 400.31 and 400.32 can be wired, on one end, to the vehicle/truck's engine/alternator (FIGS. 13, 14) for constant charging and on the other end, to the UPS distribution unit 400.26 installed within the monitoring rack; hence powering up the remaining equipment within the vehicle/truck on a as needed basis.

Referring to FIGS. 13 and 14, the environmental control within the back portion of the vehicle/truck 300 can be provided by an additional Air condition/Heater 380 (shown in block 1510) that is powered by the vehicle/truck's engine 320 (block 1500). Since the back of the vehicle/truck is to be closed at all times, the environmental conditions should remain constant. Vehicle engine 320 (block 1500) also provides power to the battery rack 400.3 (block 1520), rack detection alarm system 390 (block 1530 and lights 370 (block 1540)(See FIG. 9).

Securing Customer's Data at ADS's Facility

Referring to FIG. 1, once the backup process has been executed and completed at the customer's site 100, the backup vehicle/truck 300 returns to ADS storage facility 500. At the loading dock of ADS safe haven 500, all five racks 400 can be rolled out of the truck/vehicle 300 and into a secure facility. At this time, each one of the backup racks 400.1 will be backed up to another media such as but not limited to magnetic tapes using high-speed industrial backup system. Once this process has been completed according to the grandfather, father, son methodology, the new backup media will be sealed, labeled using internal codes, and shipped to another geographical remote ADS facility such as an ADS facility in another state. This process will ensure that the customers data is safe and well maintained even if their surrounding area was hit with a major catastrophe such as a hurricane.

The grandfather father son methodology in backup will be maintained at all levels as presented before, and works as follows: Differential backups can be performed Monday through Thursday and a full backup can be performed on Friday. The daily differential backups are considered the son tapes, the full weekly Friday backup is considered the Father tape and the last full Friday backup of the month (monthly tape) is considered the Grandfather tape.

Referring to FIGS. 1, 9 and 10, at this point, the boot drives container 400.13 can be removed from their respective racks 400.1 and secured by another department within ADS for security reasons. For example, if the Operations Department, within ADS, is in charge of running the backup process for all customers, then, once the process is complete and the backup racks are ready to be stored in their respective locations, the boot drives container 400.13 will be released to the Information Technology Department (IT) within ADS to maintain. This step is critical in order to maintain the independent two persons access to the DATA at all times.

The backup racks 400.1 can then be returned and parked in their safe location disconnected from any other connections.

The main components of ADS system have been built and tested. The experimental data results matched the anticipated ones within approximately 5% accuracy. Table 1 shown below compares the results of three different tests that were ran to backup approximately 1 Giga Byte (GB) of information. The backup over the T1 Speed (approximately 1.5 Megabits per second) over the Internet took approximately 3 hours and 15 minutes. The backup of approximately 1 GB to a backup tape took around approximately 1 hour and 10 minutes. The backup of approximately 1 GB using ADS system with a basic low quality fast ethernet switch took less than approximately 8 minutes. The results of the test confirm that the novel ADS system invention is substantially faster than any other technique and system currently available in the market place.

TABLE 1

| | Amount | | Time for |
|---|---|---|---|
| | of Data | | Data |
| Method of | to | Transfer | Transfer |
| Backup | transfer | Rate | Completion |
| Internet | 1 GB | 1.5 Mbps | 195 minutes |
| Tape Backup | 1 GB | USB Port | 70 minutes |
| | | (12 Mbps) | |
| ADS Backup | 1 GB | 100 Mbps | 8 minutes |
| System | | | |

Units:
Mbps: Mega Bits Per Second
USB: Universal Serial Bus

For the tests, the racks have been driven over approximately 600 miles and through tough road conditions. The results have proven that the novel system works.

The advantages of such a system to the end consumer, which as stated before, are numerous; among them:

Insurability Of Data

Lowered Telecommunication Costs

Flexibility Of Data Location

Immune To Internet Terrorism

Prevention Of Data Sabotage (Internal/External)

Proof of Backup Functionality

Local Disaster Recovery

Experienced And Known Vendor

A preferred truck/vehicle for the invention can include an armored bank type truck such as but not limited to Brinks®, Wells Fargo®, and the like, which can be temporarily or permanently modified to backup, store and allow for future recovery of the data. For example, the armored trucks by day can carry valuable tangible property such as cash, gold, and the like. By night the armored trucks can be retrofitted to download data to onboard storage mediums.

Businesses can use the vehicles on a daily, weekly, bi-weekly, monthly or any other scheduled basis to download data.

The novel invention system has applicability to other types of transport mediums in addition to vehicle/trucks such as armored trucks. FIG. 15 shows a plane that can both utilize the novel components of the invention and transport data as previously described. FIG. 16 shows a train that can both utilize the novel components of the invention and transport data as previously described. FIG. 17 shows a watercraft such as but not limited to a boat that can both utilize the novel components of the invention and transport data as previously described.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim:

1. A system for backing up data from inside buildings, comprising:
a transportable vehicle having a storage medium; and
means for downloading data from inside a building to the vehicle, wherein the data is backed up, stored and available for recovery from the vehicle.

2. The system of claim 1, wherein the data is selected from at least one of:
computer data, proprietary data, analog data, digital data, and magnetic storage medium data.

2. The system of claim 1, wherein the vehicle is selected from at least one of:
trucks, vans, automobiles, and customized vehicles.

3. The system of claim 1, wherein the vehicle includes: an armored vehicle.

4. The system of claim 1, wherein the downloading means includes: a wireless connection.

5. The system of claim 4, wherein the wireless communication is selected from at least one of: cellular, radio, microwave, radar, optics, and acoustic signals.

6. The system of claim 1, wherein the downloading means includes: a hardwire connection.

7. The system of claim 6, wherein the hardwire connection is selected from at least one of: cables, fiber optic cables, and conductors.

8. The system of claim 1, further comprising:
a remote location for further downloading the vehicle data for additional storage, backup and recovery.

9. A method of backing up data, comprising the steps of:
downloading data from inside a building to a vehicle; and
transporting the vehicle to another location, wherein the vehicle allows for the storage, backup and recovery of the data.

10. The method of claim 9, wherein the data is selected from at least one of:
computer data, proprietary data, analog data, digital data, and magnetic storage medium data.

11. The method of claim 9, wherein the vehicle is selected from at least one of:
trucks, vans, automobiles, and customized vehicles.

12. The method of claim 9, wherein the vehicle includes: an armored vehicle.

13. The method of claim 9, wherein the downloading step further includes:
connecting by a hardwire connection.

14. The method of claim 13, wherein the hardwire is selected from at least one of:
cables, fiber optic cables, and conductors.

15. The method of claim 9, wherein the downloading step further includes:
connecting by a wireless connection.

16. The method of claim 15, wherein the wireless connection is selected from at least one of: cellular, radio, microwave, radar, optics, and acoustic signals.

17. The method of claim 9, further comprising the step of:
downloading the data from the vehicle to a remote location from the building.

18. A method of backing up proprietary data, comprising the steps of:
downloading of information from a first computer located in a storage facility;
backing up the downloaded information to a transport vehicle; and
physically moving the transport vehicle to a remote location.

19. The method of claim 18, wherein the information includes: Giga Bytes (GBs) of information.

20. The method of claim 10, further comprising the step of:
backing up to approximately 1 Giga Byte (GB) of information in less than approximately 10 minutes.
